(19) United States
(12) Patent Application Publication
(10) Pub. No.: US 2005/0049019 A1
(43) Pub. Date: Mar. 3, 2005

(54) Sliding-type mobile communication terminal having camera interlocking device

(76) Inventor: Byoung-Gon Lee, Ichon-shi (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/749,190

(22) Filed: Dec. 31, 2003

(30) Foreign Application Priority Data
Aug. 27, 2003 (KR) 2003-59531

(51) Int. Cl. H04B 1/38

(52) U.S. Cl. 455/575.4; 455/90.3; 455/556.1

(57) ABSTRACT

A sliding-type mobile communication terminal has a camera module interlocking with a sliding motion. The sliding-type mobile communication includes a main body having a main printed circuit board and the camera module, a sliding body slidably mounted on the main body, a camera module installed in the main body, front and back openings through which the camera module can be exposed to an external side, the front and back openings being formed in front and back of the main body, respectively, and interlocking means for synchronizing the camera module with a sliding motion of the sliding body on the main body.

### FIELD OF THE INVENTION

The present invention relates to a sliding-type mobile communication terminal having a camera module interlocking with a sliding motion and, more particularly, to a sliding-type mobile communication terminal having a camera interlocking device that can expose and receive a lens part of a camera module to an external side or in the terminal in accordance with the sliding motion of a sliding body, thereby 1) minimizing the potential influence by an alien substance such as dust, 2) preventing the camera module from being damaged by outer impact, and 3) providing a reserve space to a sliding body, thereby employing other components for realizing other functions.

### DESCRIPTION OF THE PRIOR ART

In recent years, mobile communication terminals for using a mobile communication service have become a necessity. Such mobile communication terminals have come into the market in a variety of types to suit to user's taste.

The mobile communication terminals are generally divided into a bar-type, a flip-type, and a folder-type.

The bar-type mobile communication terminal is designed similar to a conventional wireless telephone, and the size thereof is tending downward to improve the portability as the capacity of battery is increased.

However, since the bar-type mobile communication terminal has a keypad exposed to an external side, there is a problem that the keypad is easily damaged. In order to solve this problem, the flip-type mobile communication terminal has been proposed.

Although the flip-type mobile communication terminal solves the problem, it has still a problem in that the length of a main body is too long for a user to conveniently carry.

Therefore, in order to solve the problem of the flip-type mobile communication terminal, the folder-type mobile communication terminal that can be designed having a shortened main body with a variety of shapes to suit to user's taste.

However, the folder-type mobile communication terminal has also problem in that, since it is designed having upper and lower bodies that are selectively folded on or unfolded from each other for the communication or carry, a hinge portion interconnecting the upper and lower bodies may be easily damaged. In addition, there may be contact impact between the upper and lower bodies in the course of folding them on each other. This may cause an outer case and an internal circuit board to be damaged.

Therefore, in order to solve the above-described general problems, a sliding-type mobile communication terminal has been recently proposed.

The sliding-type mobile communication terminal includes a main body and a sliding body that is designed to slide on the main body. Furthermore, mobile communication terminals equipped with a camera module have also been proposed. In the sliding-type mobile communication terminal, the camera module is mounted on an upper portion of the main body so that it can be exposed to an external side when the sliding body slides up.

The camera module equipped in the sliding-type mobile communication terminal is, when it is not being used, not exposed to the external side by being covered by the sliding body, foreign particles such as dust are not infiltrated into a lens part of the camera module. However, since the camera module is equipped on an opposite side of a display part, it is difficult to capture a specific image, for example, to take a picture of himself/herself.

In another conventional sliding-type mobile communication terminal, the camera module is rotatably equipped on an upper portion of the sliding body so as to make it possible for a user to take a picture of himself/herself. However, since the camera module is kept being exposed to the external side, the foreign particles such as dust may be infiltrated into the lens part of the camera module, thereby deteriorating the reliability of the camera module. Further more, the mounting of the camera module on the upper portion of the sliding body causes that it is not easy to install a cable for connecting a main circuit board and the camera module.

### SUMMARY OF THE INVENTION

It is an object of the present invention to provide a sliding-type mobile communication terminal having a camera interlocking device in which a camera module provided in the main body is configured interlocking with a sliding motion of a sliding body to allow a user to take a picture of himself/herself and at the same time allowing the lens part not to be exposed to an external side when the terminal is not being used, thereby preventing a lens part of the camera module from being affected by foreign particles such as dust.

It is another object of the present invention to provide a sliding-type mobile communication terminal having a camera interlocking device in which a camera module is installed in a main body to secure a reserve space where other functional elements are additively installed, thereby improving the function of the terminal.

In accordance with one aspect of the present invention, there is provided a sliding-type mobile communication terminal having a camera interlocking device, including a main body having a main printed circuit board; a sliding body slidably mounted on the main body; a camera module installed in the main body; front and back openings through which the camera module can be exposed to an external side, the front and back openings being formed on front and back of the main body, respectively; interlocking unit for synchronizing the camera module with a sliding motion of the sliding body on the main body.

Preferably, the interlocking unit includes a rack gear disposed on a back of the sliding body opposing the front of the main body; an intermediate idle gear disposed adjacent to the camera module and engaged with the rack gear; and a camera module gear associated with the camera module and engaged with the intermediate idle gear.

Preferably, gear ratios among the rack gear, the idle gear and the camera module gear are determined such that a lens part of the camera module is exposed to the external side through the front or back opening at a point where the sliding movement of the sliding body upward or downward is finished.

### BRIEF DESCRIPTION OF THE DRAWINGS

The above and other objects and features of the present invention will become apparent from the following description of the preferred embodiments given in conjunction with the accompanying drawings, in which:

FIG. 1 is a front perspective view of a sliding-type mobile communication terminal having a camera module interlocking with a sliding motion in accordance with a preferred embodiment of the present invention;

FIG. 2 is a rear perspective view of a sliding-type mobile communication terminal having a camera module interlocking with a sliding motion in accordance with an embodiment of the present invention;

FIG. 3 is a front perspective view of a sliding-type mobile communication terminal having a camera module interlocking with a sliding motion, in which a sliding body slides down, in accordance with a preferred embodiment of the present invention;

FIG. 4 is a rear perspective view of a sliding-type mobile communication terminal having a camera module interlocking with a sliding motion, in which a sliding body slides up, in accordance with a preferred embodiment of the present invention;

FIG. 5 is a side sectional view of a sliding-type mobile communication terminal illustrating interlocking unit in accordance with an embodiment of the present invention;

FIG. 6 is a side sectional view of a sliding-type mobile communication terminal having a camera module, in which a sliding body slides down, in accordance with a preferred embodiment of the present invention;

FIG. 7 is a side sectional view of a sliding-type mobile communication terminal having a camera module, in which a sliding body slides up, in accordance with a preferred embodiment of the present invention; and

FIG. 8 is a schematic view of interlocking unit of a sliding-type mobile communication terminal in accordance with an embodiment of the present invention.

### DETAILED DESCRIPTION OF THE PREFERRED EMBODIMENTS

A preferred embodiment of the present invention will be described more in detail hereinafter in conjunction with the accompanying drawings.

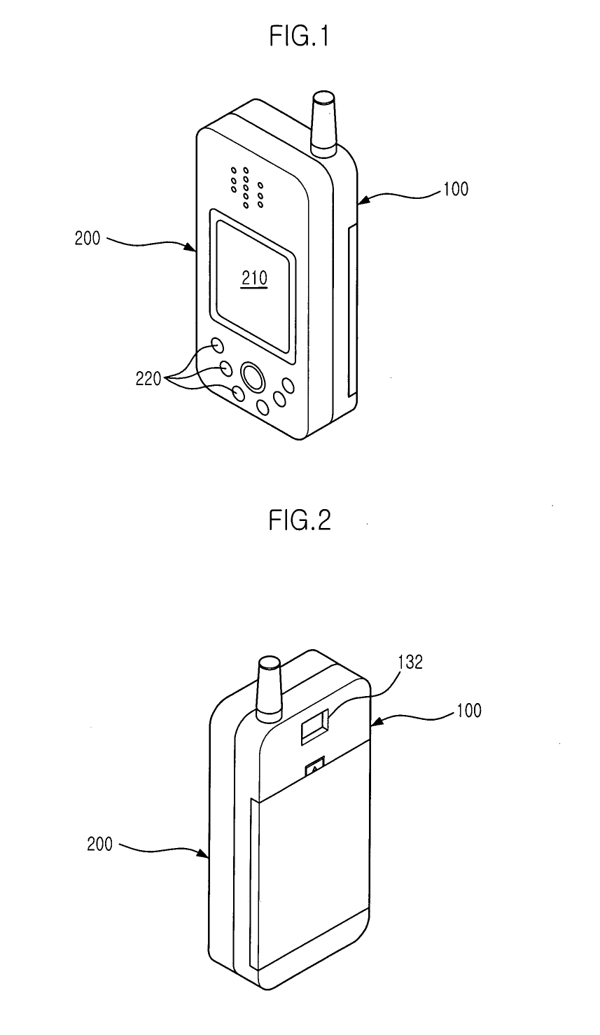

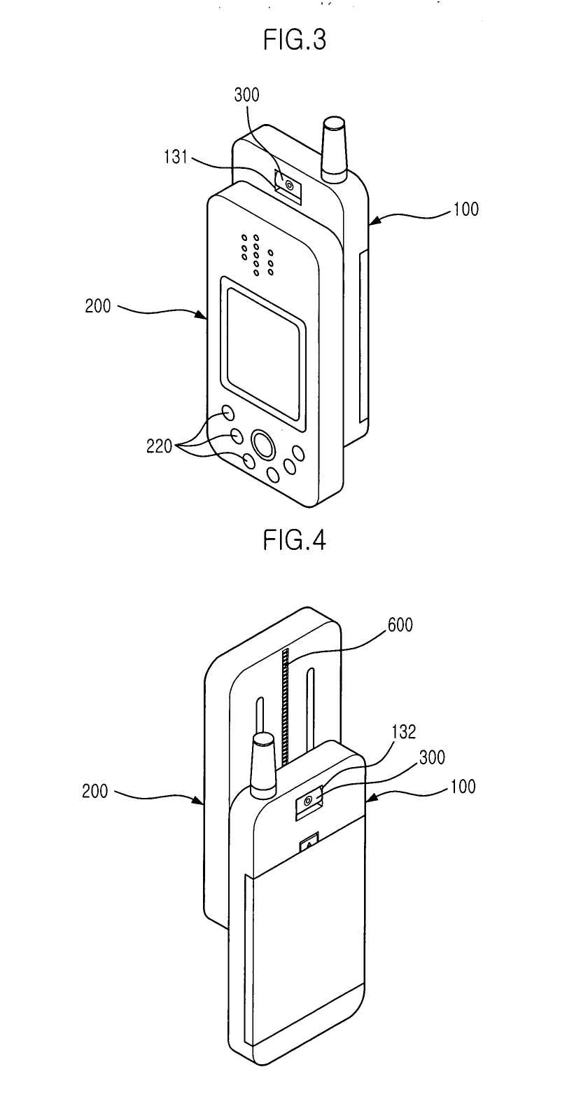

FIGS. 1 and 2 show respectively front and rear perspective views of a sliding-type mobile communication terminal having a camera module in accordance with an embodiment of the present invention, FIGS. 3 and 4 show a sliding-type mobile communication terminal having a camera module, in which a sliding body slides down and up, respectively.

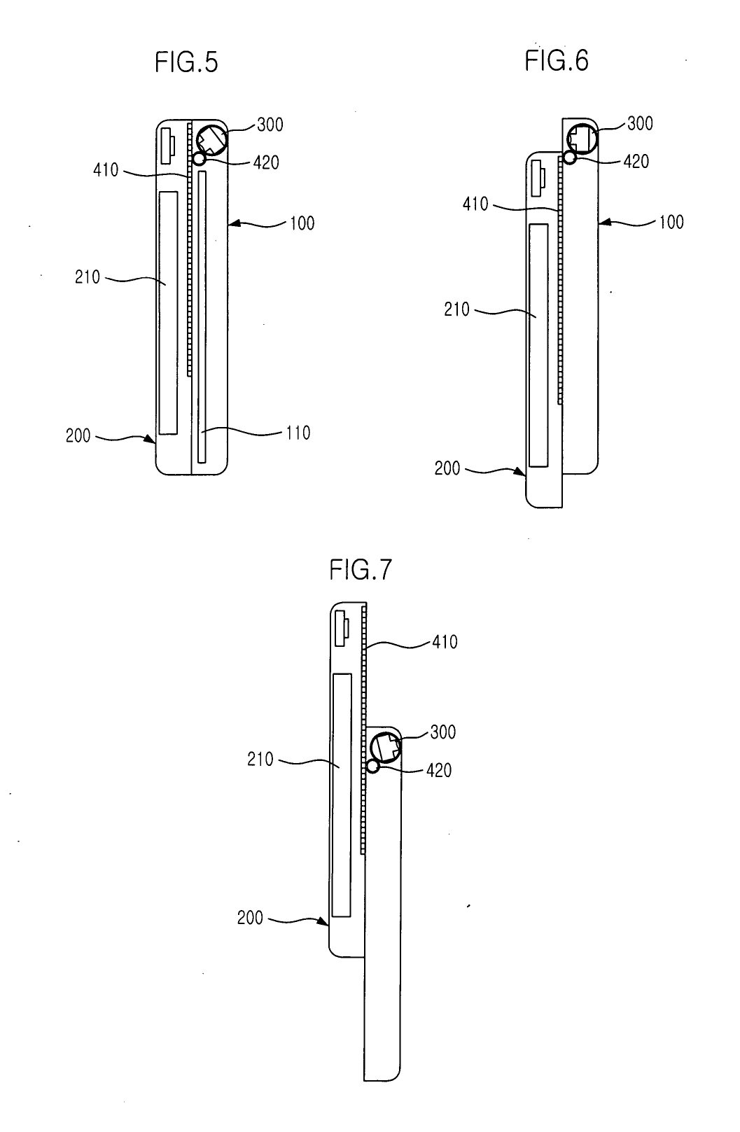

As shown in the drawings, the inventive sliding-type mobile communication terminal includes a main body 100 having a main printed circuit board 110 (see FIG. 5) and a key input part (not shown); a sliding body 200 slidably associated with the main body 100, the sliding body 200 having a display part 210 displaying an image and data and a functional button part 220; a camera module 300 provided on an upper portion of the main body 100; front and back openings 131 and 132 through which the camera module 300 is exposed to an external side, the front and back openings 131 and 132 being respectively formed in the front and back of the main body 100; and interlocking unit for synchronizing the camera module 300 with a sliding motion of the sliding body 200 on the main body 100 to selectively expose a lens part (not shown) of the camera module 300 to the external side through the front and back openings 131 and 132. The sliding-type communication terminal of the present invention further includes guide unit for guiding the sliding motion of the sliding body 200 on the main body 100.

The guide unit can be formed in any constitution as long as it can allow the sliding body 200 to slide on the main body 100. For example, as shown in FIG. 4, the main body 100 is provided with guide rails (not shown) and the sliding body 200 is provided with guide grooves 600 corresponding to the guide rails to guide the guide rails. A stopper (not shown) may be further provided to limit the sliding motion of the sliding body 200 at a point where the sliding motion of the sliding body 200 is finished. The guide rails and the guide grooves may be oppositely formed.

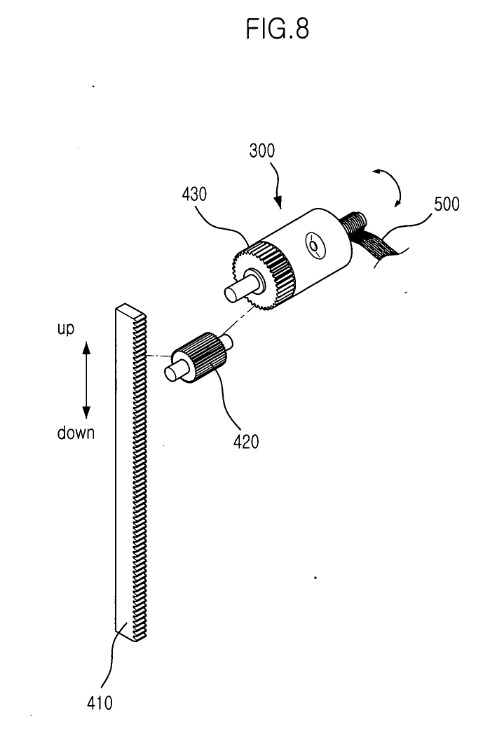

FIGS. 5 to 8 illustrate the gearing. That is, FIG. 5 shows a side sectional view of a sliding-type mobile communication terminal illustrating interlocking unit in accordance with an embodiment of the present invention; FIGS. 6 and 7 show a side sectional view of a sliding-type mobile communication terminal having a camera module, in which the sliding body 200 slides down and up, respectively; and FIG. 8 shows a schematic view of interlocking unit of a sliding-type mobile communication terminal in accordance with an embodiment of the present invention.

As shown in the drawings, the interlocking unit includes a rack gear 410 longitudinally disposed on the back of the sliding body 200 opposing the front of the main body 100; an intermediate idle gear 420 disposed adjacent to the camera module 300 and engaged with the rack gear 410; and a camera module gear 430 associated with the camera module 300 and engaged with the intermediate idle gear 420.

The rack gear 410 formed on the back of the sliding body 200 may be directly engaged with the camera module gear 430 associated with the camera module 300. At this point, the gear ratio between the rack gear 410 and the camera module gear 430 is determined considering a rotation angle of the camera module 300 with respect to a sliding distance of the sliding body 200. Therefore, the intermediate idle gear 420 may be omitted in the present invention.

In addition, gear ratios among the rack gear 410, the idle gear 420 and the camera module gear 430 are determined such that the lens part of the camera module 300 can be exposed to the external side through the front or back opening 131 or 132 at a point where the sliding movement of the sliding body 100 upward or downward is finished.

The reference numeral 500 that is not described above indicates a cable for connecting the main printed circuit board 110 to the camera module 300.

As the camera module 300 is provided on the main body 100, an additional component for realizing an additional function, for example, a stereo speaker may be further installed in a reserved space of the sliding body 200.

The operation of the above-described sliding-type communication terminal having a camera module interlocking with a sliding motion of the sliding body will be described more in detail hereinafter.

As shown in FIG. 5, when the sliding body 200 is not sliding away from the main body 100, the lens part of the camera module 300 is located not to exposed to the external side through any of the front and rear openings 131 and 132. Therefore, when the camera module is not in using, it can be prevented that the foreign particles such as dust are infiltrated into the lens part of the camera module 300.

When the user intends to take a picture of himself/herself, the sliding body 200 slides down as shown in FIG. 6. At this point, the idle gear 420 engaged with the rack gear 410 rotates counterclockwise, and the camera module gear 430 engaged with the idle gear 420 rotates clockwise, thereby rotating the camera module 300 associated with the camera module gear 430 clockwise (see FIG. 8).

Therefore, the lens part of the camera module 300 is exposed to the external side through the front opening 131 of the main body 100 so that the user can take a picture of himself/herself.

Meanwhile, when the user intends to take a picture through the back opening 132 of the main body 100, the sliding body 200 slides up as shown in FIG. 7. At this point, the idle gear 420 engaged with the rack gear 410 rotates clockwise, and the camera module gear 430 engaged with the idle gear 420 rotates counterclockwise, thereby rotating the camera module 300 associated with the camera module gear 430 counterclockwise (see FIG. 8).

Therefore, the lens part of the camera module 300 is exposed to the external side through the back opening 131 of the main body 100 so that the user can take a picture of other objects.

As described above, since the sliding-type mobile communication terminal of the present invention has a camera module interlocking with a sliding motion of the sliding body, the user can take a picture of himself/herself and prevents a lens part of a camera module from being affected by foreign particles such as dust by allowing the lens part not to be exposed to an external side when the terminal is not being used.

In addition, since the camera module is installed in the main body, a reserve space for employing other components for realizing other functions can be provided on the sliding body, thereby improving the function of the terminal.

Furthermore, since the cameral module is installed in the main body provided with the main printed circuit board, it is easy to design a cable for connecting the main printed circuit board to the camera module when compared with a case where the camera module is installed in the sliding body.

While the present invention has been described with respect to the particular embodiments, it will be apparent to those skilled in the art that various changes and modifications may be made without departing from the scope of the invention as defined in the following claims.

1. A sliding-type mobile communication terminal having a camera interlocking device, comprising:
a main body having a main printed circuit board;
a sliding body slidably mounted on the main body;
a camera module being installed in the main body;
front and back openings through which the camera module is exposed to an external side, the front and back openings being formed in front and back of the main body, respectively; and
interlocking means for rotating the camera module with a sliding motion of the sliding body on the main body.

2. The sliding-type mobile communication terminal as recited in claim 1, further comprising guide means for guiding the sliding motion of the sliding body on the main body.

3. The sliding-type mobile communication terminal as recited in claim 1, wherein the interlocking means includes:
a rack gear formed on a surface of the sliding body in a sliding direction; and
a camera module gear engaged with the rack gear to rotate the camera module.

4. The sliding-type mobile communication terminal as recited in claim 1, the interlocking means includes:
a rack gear disposed on a back of the sliding body opposing the front of the main body;
an intermediate idle gear disposed adjacent to the camera module and engaged with the rack gear; and
a camera module gear associated with the camera module and engaged with the intermediate idle gear.

5. The sliding-type mobile communication terminal as recited in claim 3, wherein a gear ratio between the rack gear and the camera module gear is determined such that a lens part of the camera module is exposed to the external side through the front or back opening at a point where the sliding movement of the sliding body upward or downward is finished.

6. The sliding-type mobile communication terminal as recited in claim 4, wherein gear ratios among the rack gear, the idle gear and the camera module gear are determined such that a lens part of the camera module can be exposed to the external side through the front or back opening at a point where the sliding movement of the sliding body upward or downward is finished.

7. The sliding-type mobile communication terminal as recited in claim 2, wherein the guide means includes:
guide rails formed on one of the sliding and stationary bodies;
guide grooves formed on the other one of the sliding and stationary bodies to guide the guide rails; and
a stopper for limiting the sliding motion of the sliding body at a point where the sliding motion of the sliding body is finished.
